(19) United States
(12) Patent Application Publication
(10) Pub. No.: US 2002/0073301 A1
(43) Pub. Date: Jun. 13, 2002

(54) Hardware for use with compiler generated branch information

(75) Inventors: James Allan Kahle, Austin, TX (US); Charles Roberts Moore, Austin, TX (US)

Correspondence Address: Joseph P. Lally, DEWAN & LALLY, L.L.P., P.O. Box 684749, Austin, TX, 78768-4749, US

(73) Assignee: International Business Machines Corporation

(21) Appl. No.: 09/731,617

(22) Filed: Dec. 7, 2000

(51) Int. Cl. G06F 9/00

(52) U.S. Cl. 712/235

(57) ABSTRACT

A method of executing microprocessor instructions and an associated microprocessor are disclosed. Initially, a conditional branch instruction is fetched from a storage unit such as an instruction cache. Branch prediction information embedded in the branch instruction is detected by a fetch unit of the microprocessor. Depending upon the state of the branch prediction information, instructions from the branch-taken path and the branch-not-taken path of the branch instruction are fetched. The branch-not-taken path instructions and the branch-taken path instruction may be speculatively executed. Upon executing the conditional branch instruction, the speculative results from the branch-taken path are discarded if the branch is not taken and speculative results from the branch-not-taken path are discarded if the branch is taken. The branch prediction information may include compiler generated information indicative of the context in which the conditional branch instruction is used. In one embodiment, the branch prediction information causes instruction fetching from both the taken and non taken branches if the compiler determines the branch instruction to unpredictable. In another embodiment, fetching instructions from the branch-taken path includes fetching a predetermined number of instructions from the branch-taken path and a predetermined number of instructions from the branch-not-taken path. In another embodiment, instructions are fetch down the branch-not-taken path until a subsequent branch instruction is encountered.

### BACKGROUND

1. Field of the Present Invention

The present invention generally relates to the field of microprocessors and more particularly to a microprocessor including hardware designed to minimize branch misprediction by using compiler generated branch information to speculatively execute instructions following a branch condition.

2. History of Related Art

A major challenge for designers of gigahertz microprocessors is to take advantage of state-of-the-art technologies while maintaining compatibility with the enormous base of installed software designed for operation with a particular instruction set architecture (ISA). To address this problem, designers have implemented “layered architecture” microprocessors that are adapted to receive instructions formatted according to an existing ISA and to convert the instruction format of the received instructions to an internal ISA that is more suitable for operation in gigahertz execution units.

Because a layered architecture adds to the processor pipeline and increases that number of instructions that are potentially “in flight” at any given time, the branch mispredict penalty associated with a layered architecture is of great concern. Dynamic mechanisms for predicting branches can be highly accurate in predicting certain types of branches, such as the branches associated with a loop that is executed multiple times. For a frequently encountered class of branches (referred to herein as random branches) such as a branch predicated upon a comparison between the contents of a random memory location and the contents of a register, however, conventional prediction mechanisms are not typically effective in reducing the misprediction rate significantly below 50%. Because of the large misprediction penalty associated with superscalar architectures in general and layered architecture processors in particular, it would be highly desirable to address the expensive misprediction penalty associated with random branches.

### SUMMARY OF THE INVENTION

The problem identified above is addressed by a method of executing microprocessor instructions and an associated microprocessor according to the present invention. Initially, a conditional branch instruction is fetched from a storage unit such as an instruction cache. A fetch unit of the microprocessor detects branch prediction information embedded in the branch instruction. Depending upon the state of the branch prediction information, instructions from the branch-taken path and the branch-not-taken path of the branch instruction are fetched. The branch-not-taken path instructions and the branch-taken path instruction may be speculatively executed. Upon executing the conditional branch instruction, the speculative results from the branch-taken path are discarded if the branch is not taken and speculative results from the branch-not-taken path are discarded if the branch is taken. The branch prediction information may include compiler-generated information indicative of the context in which the conditional branch instruction is used. In one embodiment, the branch prediction information causes instruction fetching from both the taken and not taken branches if the compiler determines the branch instruction to unpredictable. In another embodiment, fetching instructions from the branch-taken path includes fetching a predetermined number of instructions from the branch-taken path and a predetermined number of instructions from the branch-not-taken path. In another embodiment, instructions are fetch down the branch-not-taken path until a subsequent branch instruction is encountered.

### BRIEF DESCRIPTION OF THE DRAWINGS

Other objects and advantages of the invention will become apparent upon reading the following detailed description and upon reference to the accompanying drawings in which:

FIG. 1 is a block diagram of a data processing system;

FIG. 2 is a block diagram illustrating selected features of a processor suitable for use in the data processing system of FIG. 1;

FIG. 3 is an exemplary code segment suitable for implementing the conditional branch information of the present invention;

FIG. 4 illustrates a branch conditional statement according to the present invention; and

FIG. 5 is a block digram illustrating features of a branchprediction unit according to one embodiement of the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF A PREFERRED EMBODIMENT OF THE PRESENT INVENTION

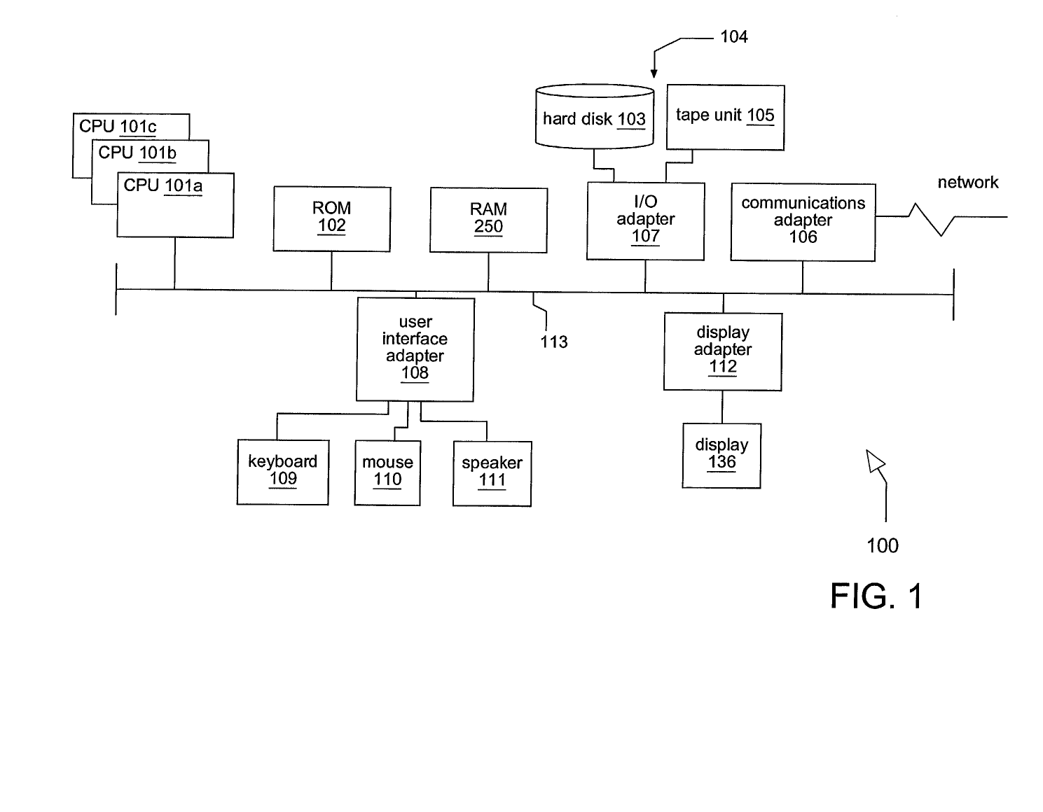

Referring now to FIG. 1, an embodiment of a data processing system 100 according to the present invention is depicted. System 100 has one or more central processing units (processors) 101a, 101b, 101c, etc. (collectively or generically referred to as processor(s) 101. In one embodiment, each processor 101 may comprise a reduced instruction set computer (RISC) microprocessor. Additional information concerning RISC processors in general is available in C. May et al. Ed., PowerPC Architecture: A Specification for a New Family of RISC Processors, (Morgan Kaufmann, 1994 2d edition). Processors 101 are coupled to system memory 250 and various other components via system bus 113. Read only memory (ROM) 102 is coupled to the system bus 113 and may include a basic input/output system (BIOS), which controls certain basic functions of system 100. FIG. 1 further depicts an I/O adapter 107 and a network adapter 106 coupled to the system bus 113. I/O adapter 107 may be a small computer system interface (SCSI) adapter that communicates with a hard disk 103 and/or tape storage drive 105. I/O adapter 107, hard disk 103, and tape storage device 105 are collectively referred to herein as mass storage 104. A network adapter 106 interconnects bus 113 with an outside network enabling data processing system 100 to communicate with other such systems. Display monitor 136 is connected to system bus 113 by display adapter 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O busses for connecting peripheral devices such as hard disk controllers, network adapters, and graphics adapters include the Peripheral Components Interface (PCI) bus according to PCI Local Bus Specification Rev. 2.2 available from the PCI Special Interest Group, Hillsboro Oreg., and incorporated by reference herein. Additional input/output devices are shown as connected to system bus 113 via user interface adapter 108 and display adapter 112. A keyboard 109, mouse 110, and speaker 111 all interconnected to bus 113 via user interface adapter 108, which may include, for example, a SuperI/O chip integrating multiple device adapters into a single integrated circuit. For additional information concerning one such chip, the reader is referred to the PC87338/PC97338 ACPI 1.0 and PC98/99 Compliant SuperI/O data sheet from National Semiconductor Corporation (November 1998) at www.national.com. Thus, as configured in FIG. 1, system 100 includes processing means in the form of processors 101, storage means including system memory 250 and mass storage 104, input means such as keyboard 109 and mouse 110, and output means including speaker 111 and display 136. In one embodiment a portion of system memory 250 and mass storage 104 collectively store an operating system such as the AIX® operating system from IBM Corporation to coordinate the functions of the various components shown in FIG. 1. Additional detail concerning the AIX operating system is available in AIX Version 4.3 Technical Reference: Base Operating System and Extensions, Volumes 1 and 2 (order numbers SC23-4159 and SC23-4160); AIX Version 4.3 System User's Guide: Communications and Networks (order number SC23-4122); and AIX Version 4.3 System User's Guide: Operating System and Devices (order number SC23-4121) from IBM Corporation at www.ibm.com and incorporated by reference herein.

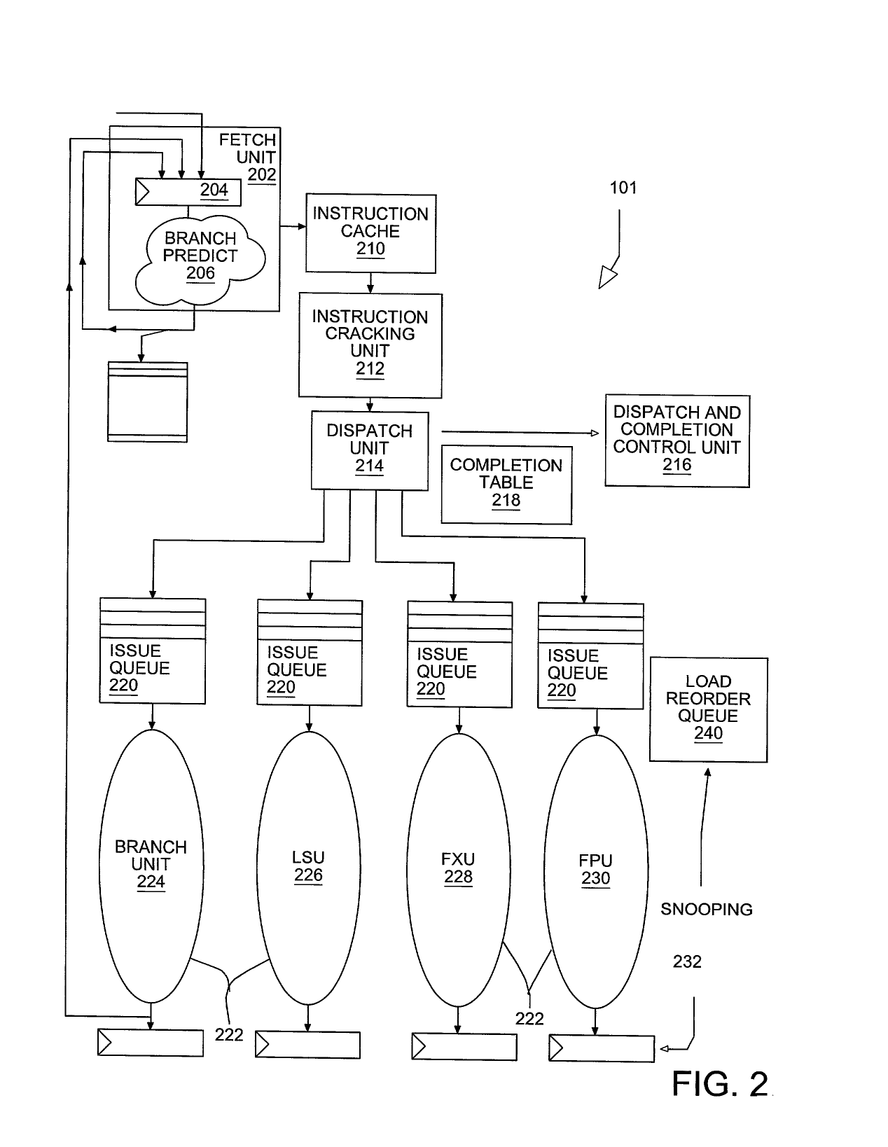

Turning now to FIG. 2, a simplified block diagram of a processor 101 according to one embodiment of the present invention is illustrated. Processor 101 as depicted in FIG. 2 includes an instruction fetch unit 202 suitable for generating an address of the next instruction to be fetched. The fetched instruction address generated by fetch unit 202 is loaded into a next instruction address latch 204 and provided to an instruction cache 210.

Fetch unit 202 further includes branch prediction logic 206. As its name suggests, branch prediction logic 206 is adapted to predict the outcome of a decision that effects the program execution flow. The ability to correctly predict branch decisions is a significant factor in the overall ability of processor 101 to achieve improved performance by executing instructions speculatively and out-of-order.

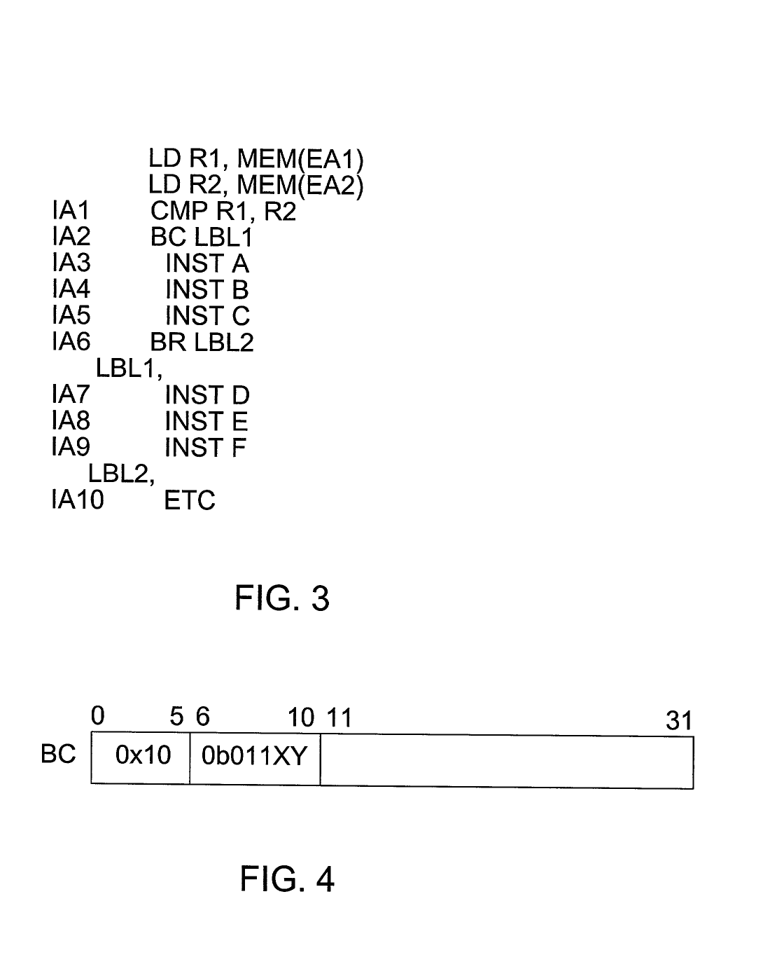

The address produced by fetch unit 202 is provided to an instruction cache 210, which contains a subset of the contents of system memory in a high-speed storage facility. If the address instruction generated by fetch unit 202 corresponds to a system memory location that is currently replicated in instruction cache 210, instruction cache 210 forwards the corresponding instruction to cracking logic 212. If the instruction corresponding to the instruction address generated by fetch unit 202 does not currently reside in instruction cache 210, the contents of instruction cache 210 must be updated with the contents of the appropriate locations in system memory before the instruction can be forwarded to cracking logic 212. Additional details of instruction fetch unit 202 are described in greater detail below with respect to FIG. 3.

Cracking logic 212 is adapted to modify an incoming instruction stream to produce a set of instructions optimized for executing in an underlying execution unit at extremely high operating frequencies (i.e., operating frequencies exceeding 1 GHz). Cracking logic 212 may, for example, receive instructions in a 32-bit wide format such as instructions supported by the PowerPC® instruction set. Detailed information regarding the PowerPC® instruction set is available in the PowerPC® Microprocessor Family: The Programming Environments for 32-Bit Microprocessors available from IBM Corporation. (Order No. G522-0290-01), which is incorporated by reference herein.

The format of the instructions generated by cracking logic 212 may include explicit fields for information that is merely implied in the format of the fetched instructions such that the format of instructions generated by cracking logic 212 is wider than the format of instructions. In one embodiment, for example, the fetched instructions are encoded according to a 32-bit instruction format and the format of instructions generated by cracking logic 212 is 64 or more bits wide. Cracking logic 212 is designed to generate these wide instructions according to a predefined set of cracking rules. In addition, cracking unit 212 may logically organize a set of instructions into one or more instruction groups to simply exception and completion handling logic. Instruction groups are disclosed in greater detail in U.S. patent application Ser. No. 09/428,399 entitled Instruction Group Organization and Exception Handling in a Microprocessor, filed Oct. 28, 1999, which shares a common assignee with the present application and is incorporated by reference herein.

Returning now to FIG. 2, the wide instructions generated in the preferred embodiment of cracking unit 212 are forwarded to dispatch unit 214. Dispatch unit 214 is responsible for determining which instructions are capable of being executed and forwarding these executable instructions to issue queues 220. In addition, dispatch unit 214 communicates with dispatch and completion control logic 216 to keep track of the order in which instructions were issued and the completion status of these instructions to facilitate out-of-order execution. In an embodiment of processor 101 in which cracking unit 212 organizes incoming instructions into instruction groups, each instruction group is assigned a group tag (GTAG) by completion and control logic 216 that conveys the ordering of the issued instruction groups. As an example, dispatch unit 214 may assign monotonically increasing values to consecutive instruction groups. With this arrangement, instruction groups with lower GTAG values are known to have issued prior to (i.e., are older than) instruction groups with larger GTAG values. In association with dispatch and completion control logic 216, a completion table 218 is utilized in one embodiment of the present invention to track the status of issued instruction groups.

In the embodiment of processor 101 depicted in FIG. 2, instructions are issued from dispatch unit 214 to issue queues 220 where they await execution in corresponding execution units 222. Processor 101 may include a variety of types of executions pipes, each designed to execute a subset of the processor's instruction set. In one embodiment, execution units 222 may include a branch unit 224, a load store unit 226, a fixed-point arithmetic unit 228, and a floating point unit 230. Each execution unit 222 may comprise two or more pipeline stages.

Instructions stored in issue queues 220 may be issued to execution units 222 using any of a variety of issue priority algorithms. In one embodiment, for example, the oldest pending instruction in an issue queue 220 is the next instruction issued to execution units 222. In this embodiment, the GTAG values assigned by dispatch unit 214 are utilized to determine the relative age of instructions pending in the issue queues 220.

Prior to issue, the destination register operand of each instruction is assigned to an available rename register. When an instruction is ultimately forwarded from issue queues 120 to the appropriate execution unit, the execution unit performs the operation indicated by the instruction's opcode and writes the instruction's result to the instruction's rename register by the time the instruction reaches a finish stage (indicated by reference numeral 132) of the pipeline. A mapping is maintained between the rename registers and their corresponding architected registers. When all instructions in an instruction group (and all instructions in older instruction groups) finish without generating an exception, a completion pointer in the completion table 218 is incremented to the next instruction group.

When the completion pointer is incremented to a new instruction group, the rename registers associated with the instructions in the old instruction group are released thereby committing the results of the instructions in the old instruction group. If one or more instructions older than a finished (but not yet committed) instruction generate an exception, the instruction generating the exception and all younger instructions are flushed and a rename recovery routine is invoked to return the rename register mapping to the last known valid state. In this manner, processor 101 enables speculative and out-of-order instruction execution.

Speculative instruction execution is most frequently encountered in conjunction with conditional branches. When instruction fetch unit 202 fetches a conditional branch instruction from instruction cache 210, the fetch unit 202 cannot know with certainty which instruction will be executed immediately after the conditional branch is executed because the condition on which the branch is dependent is evaluated when the conditional branch is executed. To prevent an instruction fetch stall from occurring following every conditional branch instruction, branch prediction unit 206 is included in fetch unit 202 to predict the “outcome” of conditional branches.

The prediction may be based on prior executions of the same conditional branch statement using an instruction history table that records the results conditional branch instruction results. Branch prediction may also be improved by incorporating prediction information into the branch instruction itself. In this approach, the compiler evaluates the context in which a conditional branch statement is executed and makes a determination, if possible, about whether the branch is likely to be taken. The conditional branch statement at the end of a loop that is executed 100 times, for example, branches to the same instruction address 99% of the time. In this case, the compiler could embed information in the branch instruction itself (assuming there are bits positions available in the instruction) to tell the hardware the direction in which way the branch is most likely to go.

Referring now to FIG. 3, a sample code segment is presented to illustrate an example of a context in which branch prediction is ineffective. The depicted code segment includes a conditional branch instruction at instruction address IA2 that is dependent upon a comparison between the contents of two memory locations. Because the memory locations EA1 and EA2 may contain any random value, branch prediction algorithms are unlikely to predict the outcome of this branch consistently. Thus, the conditional branch instruction at IA2 is said to be unpredictable. In other words, the likelihood of correctly predicting the conditional branch is approximately 50% and the ability to improve the percentage significantly using branch history information is limited. In one embodiment of the invention, an instruction is referred to as unpredictable if the compiler determines the probability of correctly predicting the branch to be less than 75%.

Under these circumstances, the conditional branch instruction carries a significant misprediction cost because the instruction will incur a branch mispredict penalty approximately half the time it is executed. Branch misprediction causes microprocessor 101 to flush a potentially large number of in-flight instructions and to restore the state of the instruction address latch and the architected registers to the state that existed prior to execution of the mispredicted branch. Microprocessor 101 according to the present invention addresses the branch mispredict penalty associated with random branches (i.e., branch instructions that are not susceptible to highly accurate branch prediction), by speculatively fetching and executing both sides (i.e., the branch-taken side and the branch not take side) of a branch sequence based upon branch prediction information that is encoded in the conditional branch instruction. When the branch instruction is executed, the results from the correctly predicted side of the branch can be committed to register files while the results from the wrongly predicted side are discarded. In this manner, the relatively expensive branch mispredict penalty is avoided for the relatively modest price associated with speculatively executing a few additional instructions.

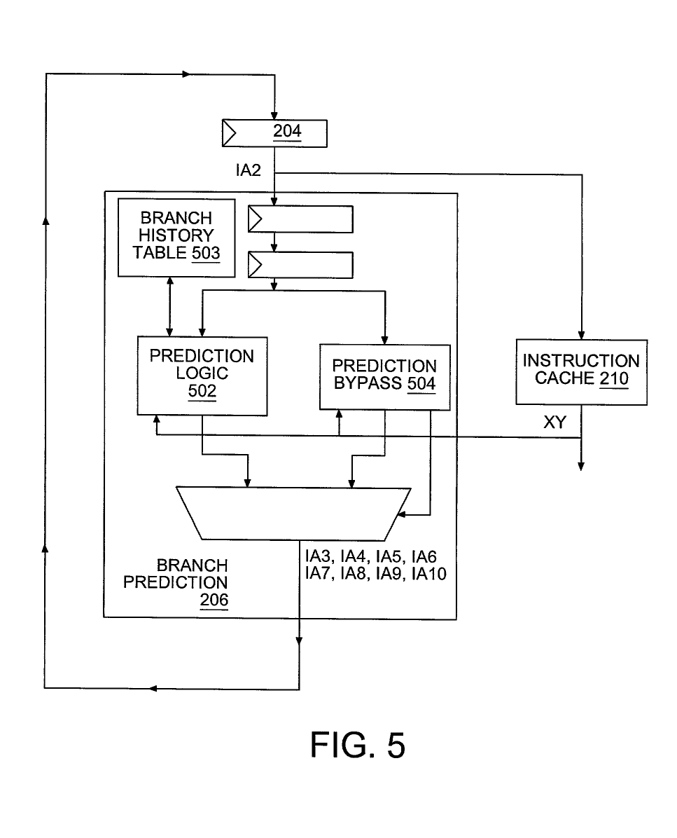

Turning now to FIG. 5, additional detail of branch prediction unit 206 according to one embodiment of the invention is presented. In the depicted embodiment, branch prediction unit 206 includes prediction logic 502 that is configured to predict branches when enabled. Branch prediction unit 206 also includes prediction bypass unit 504 that is used when processor 101 determines that branch prediction is not effective with respect to a particular conditional branch.

In the depicted embodiment, prediction logic 502 and prediction bypass unit 504 both utilized prediction information (identified as XY in the figure) that is supplied by the branch instruction retrieved from instruction cache 210. In one embodiment, the prediction information represents compiler-generated bits of information that are incorporated into the opcode bits of the conditional branch instruction. Branch prediction unit 206 receives the branch prediction information when the instruction is retrieved from the instruction cache and forwards the information to prediction logic 502 and prediction bypass unit 504. Depending on the state of the prediction information, branch prediction unit 206 uses either prediction logic 502 to predict the branch (perhaps in conjunction with branch history table 503) and forwards the prediction result (i.e., the instruction address of the predicted next instruction) back to instruction address latch 204 or uses prediction bypass unit 504 to issue instruction addresses representing both sides of the branch under consideration.

Referring momentarily to FIG. 4, a conditional branch instruction formatted in accordance with the PowerPC® instruction set and suitable for use with the present invention is presented. In the illustrated example, branch conditional (BC) instruction 400 includes a 6-bit primary opcode field 402, and a 5-bit secondary opcode field 404 Secondary opcode field 404 indicates whether the branch is taken if the appropriate condition (represented by a bit in the condition register) is true or false. In addition, the depicted embodiment of secondary opcode field 404 includes a pair of branch prediction information bits, identified as the XY bits. The XY bits are generated during compilation of the executable code based upon the compiler's interpretation of the context in which the conditional branch statement is used. If the compiler determines that branch prediction is unlikely to significantly improve the branch prediction rate, the compiler can encode the XY bits with an appropriate value to indicate that branch prediction is to be bypassed. Similarly, if the compiler determines from its context that a particular branch conditional instruction is susceptible to accurate branch prediction, the compiler can encode the XY bits of the branch instruction accordingly.

Returning now to FIG. 5, when the instruction address of a conditional branch instruction is clocked out of instruction address latch 204, it is presented to instruction cache 210. In response, instruction cache 210 provides the appropriate instruction to the execution dispatch/execution pipeline below (not depicted in FIG. 5). In addition, the branch prediction information bits (the XY bits) are provided to prediction logic 502 and prediction bypass unit 504 of branch prediction unit 206. Appropriate latching circuitry may be included in branch prediction unit 206 to ensure that the conditional branch's instruction address arrives at prediction logic 502 and prediction bypass unit 504 at the same time as the instruction's branch prediction information.

If the branch prediction information indicates that branch prediction is likely to be ineffective, prediction bypass unit 504 is used to cause instructions on both sides of the conditional branch to be fetched and provided to the execution pipeline. An example of the operation of branch prediction unit 206 is illustrated in FIG. 5 with respect to the code segment presented in FIG. 3. When the instruction address (IA2) of the conditional branch instruction comes out of instruction latch 204, it retrieves the 32-bit instruction from instruction cache 210 and forwards the instruction to the underlying dispatch/execution circuitry. In addition, the instruction's branch prediction bits are forwarded to prediction bypass unit 504 and prediction logic 502. Because the particular branch conditional instruction illustrated in FIG. 3 is used in a context in which branch prediction is not likely to be effective, the compiler has presumably encoded the branch prediction bits of the branch conditional instruction with the appropriate code to invoke branch prediction bypass unit 504.

Upon receiving the XY bits from instruction cache 210 (at the same time as it receives the branch conditional instruction address), branch prediction bypass unit 504 generates a sequence of instruction addresses representing both sides of the branch conditional sequence. To facilitate the generation of instruction addresses, prediction bypass unit 504 may receive branch address information from instruction cache 210 and may include an adder circuit for calculating the branch-taken address. Thus, branch prediction bypass unit 504 outputs a sequence of instruction addresses that causes fetch unit 202 to fetch instructions from the branch-not-taken leg of the branch conditional segment (IA3, IA4, IA5, and IA6) and from the branch-taken leg (IA7, IA8, IA9, and IA10). In one embodiment, branch prediction bypass unit 504 fetches a predetermined number of instructions from the branch-taken path of the branch instruction and a predetermined number of instructions from the branch-not-taken path upon detecting an unpredictable branch. In another embodiment, instructions are fetched down the branch-not-taken path until a subsequent branch instruction is encountered. Thus, in the illustrated example, one embodiment of branch prediction bypass unit 504 might simply fetch three (or some other predetermined number) of instructions down both sides of the branch. In another embodiment, bypass unit 504 may fetch instructions down the branch-not-taken path (i.e., the path beginning at IA3) until the subsequent branch instruction at IA6 is encountered. In this manner, compiler generated branch prediction information is used to minimize the branch mispredict penalty in highly pipelined microprocessors thereby potentially improving processor performance.

It will be apparent to those skilled in the art having the benefit of this disclosure that the present invention contemplates improved microprocessor performance by incorporating prediction information into conditional branch instruction and using the prediction information to speculatively execute both sides of a branch when prediction is unlikely to yield consistently accurate results. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A method of executing instructions in a microprocessor comprising:
fetching a conditional branch instruction from an instruction cache;
detecting branch prediction information in the branch instruction; and
responsive to the branch prediction information, fetching instructions from both a branch-taken path and from a branch-not-taken path of the branch instruction.

2. The method of claim 1, further comprising:
speculatively executing the instructions from the branch-taken path and the branch-not-taken path of the branch instruction;
executing the conditional branch instruction; and
based upon the outcome of the conditional branch instruction, discarding results from the speculatively executed instructions from the branch-taken path if the branch is not taken and discarding results from the branch-not-taken path if the branch is taken.

3. The method of claim 1, wherein the branch prediction information comprises compiler generated information indicative of the context in which the conditional branch instruction is used.

4. The method of claim 3, wherein the branch prediction information causes instruction fetching from both the taken and not taken branches if the branch instruction is determined by the compiler to be unpredictable.

5. The method of claim 1, wherein fetching instructions from the branch-taken path comprises fetching a predetermined number of instructions from the branch-taken path and wherein fetching instructions from the branch-not-taken path comprises fetching a predetermined number of instructions from the branch-not-taken path.

6. The method of claim 1, wherein fetching instructions from the branch-not-taken path comprises fetching instructions down the branch-not-taken path until a subsequent branch instruction is encountered.

7. A microprocessor comprising:
an instruction cache suitable for storing a set of processor executable instructions and configured to receive an instruction address and to retrieve an instruction corresponding to the instruction address; and
a fetch unit connected to the instruction cache and configured to generate an instruction address;
wherein the fetch unit is configured to detect branch instruction information in a branch instruction retrieved from the instruction cache and further configured to fetch instructions from both a branch-taken path and a branch-not-taken path of the branch instruction depending upon the state of the branch instruction information.

8. The microprocessor of claim 7, wherein the branch prediction unit includes prediction logic enabled by the branch instruction information and configured to predict the result of a branch instruction.

9. The microprocessor of claim 8, wherein the branch predicution unit includes a prediction bypass unit enabled by the branch prediction information and configured to issue instruction addresses from a branch-taken path and a branch-not-taken path of the branch instruction.

10. The microprocessor of claim 7 wherein the processor is configured to speculatively execute the instructions from the branch-taken path and from the branch-not-taken path of the branch instruction, execute the conditional branch instruction, and, based upon the outcome of the conditional branch instruction, discard results from the speculatively executed instructions from the branch-taken path if the branch is not taken and discarding results from the branch-not-taken path if the branch is taken.

11. The microprocessor of claim 7 configured to receive branch prediction information comprises compiler generated information indicative of the context in which the conditional branch instruction is used.

12. The microprocessor of claim 7, wherein the microprocessor is configured to fetch a predetermined number of instructions from the branch-taken path and further configured to fetch a predetermined number of instructions from the branch-not-taken path depending upon the state of the branch instruction information.

13. The microprocessor of claim 7, configured for fetching instructions down the branch-not-taken path until a subsequent branch instruction is encountered depending upon the state of the branch instruction information.

14. A data processing system including processor, memory, input means, and display, the processor including:
an instruction cache suitable for storing a set of processor executable instructions and configured to receive an instruction address and to retrieve an instruction corresponding to the instruction address; and
a fetch unit connected to the instruction cache and configured to generate an instruction address;
wherein the fetch unit is configured to detect branch instruction information in a branch instruction retrieved from the instruction cache and further configured to fetch instructions from both a branch-taken path and a branch-not-taken path of the branch instruction depending upon the state of the branch instruction information.

15. The microprocessor of claim 14, wherein the branch prediction unit includes prediction logic enabled by the branch instruction information and configured to predict the result of a branch instruction.

16. The microprocessor of claim 15, wherein the branch predicution unit includes a prediction bypass unit enabled by the branch prediction information and configured to issue instruction addresses from a branch-taken path and a branch-not-taken path of the branch instruction.

17. The microprocessor of claim 14 wherein the processor is configured to speculatively execute the instructions from the branch-taken path and from the branch-not-taken path of the branch instruction, execute the conditional branch instruction, and, based upon the outcome of the conditional branch instruction, discard results from the speculatively executed instructions from the branch-taken path if the branch is not taken and discarding results from the branch-not-taken path if the branch is taken.

18. The microprocessor of claim 14 configured to receive branch prediction information comprises compiler generated information indicative of the context in which the conditional branch instruction is used.

19. The microprocessor of claim 14, wherein the microprocessor is configured to fetch a predetermined number of instructions from the branch-taken path and further configured to fetch a predetermined number of instructions from the branch-not-taken path depending upon the state of the branch instruction information.
